(19) United States
(12) Patent Application Publication
(10) Pub. No.: US 2019/0176529 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,371

(22) Filed: Dec. 5, 2018

(30) Foreign Application Priority Data
Dec. 13, 2017 (JP) 2017-238846

(51) Int. Cl. B60C 11/03; B60C 11/12

(52) U.S. Cl. CPC B60C 11/0309; B60C 11/0302; B60C 11/1204; B60C 2011/1213; B60C 2011/0358; B60C 2011/0388; B60C 2011/0346

(57) ABSTRACT

A pneumatic tire includes a center land portion between two center main grooves, a mediate land portion between a center main groove and a shoulder main groove, and a shoulder land portion between the shoulder main groove and a grounding end (E). Each of the center main grooves extends in a zigzag manner by alternately arranging long first groove portions and short second groove portions that are inclined with respect to a circumferential direction of the tire, respectively. A bulging portion in a tire width direction is formed in the center land portion. Each of the first groove portions of the center main groove is inclined such that a portion to be grounded later heads toward the grounding end (E) side. Each first lateral groove traverses the mediate land portion and the shoulder land portion and forms a notch in the bulging portion in the center land portion.

### CROSS-REFERENCE TO RELATED APPLICATIONS

This application is based on Japanese Patent Application No. 2017-238846 (filed on Dec. 13, 2017) and claims priority from Japanese Patent Application No. 2017-238846. The present disclosure incorporates entire contents of Japanese Patent Application No. 2017-238846.

### TECHNICAL FIELD

The present disclosure relates to a pneumatic tire.

### BACKGROUND ART

As disclosed in Patent Document 1 or Patent Document 2, a pneumatic tire having a main groove that extends in a zigzag manner in a circumferential direction of a tire is known. Since the main groove has a zigzag shape, such pneumatic tire is excellent in traction performance, but drainage performance is not sufficient.

Further, as disclosed in Patent Document 1 or Patent Document 3, there has been known a pneumatic tire including a center land portion at the center of a tire width direction, a shoulder land portion at both sides in the tire width direction, and a mediate land portion between the center land portion and the shoulder land portion, in which lateral grooves traverses the shoulder land portion and the mediate land portion. In such a pneumatic tire, drainage performance is good since water can pass through the inside of the lateral grooves.

Patent Document 1: JP-A-2010-274695

Patent Document 2: JP-A-2014-240204

Patent Document 3: JP-A-2002-002229

### DISCLOSURE OF THE INVENTION

### Problem that the Invention is to Solve

In a pneumatic tire having a center land portion, a mediate land portion, and a shoulder land portion, the applicant has considered to form a main groove at both sides of the center land portion in a zigzag shape and to provide a bulging portion in a tire width direction in the center land portion. In this case, it is expected that drainage performance and traction performance are not sufficiently exhibited in the vicinity of the bulging portion of the tire width direction of the center land portion.

Therefore, the present disclosure is to provide a pneumatic tire with good drainage performance and traction performance.

### Means for Solving the Problem

A pneumatic tire of an embodiment includes: two center main grooves on a tire equator side and two shoulder main grooves on a grounding end side of the tire as main grooves extending in a circumferential direction of the tire; a center land portion between the two center main grooves; a mediate land portion between the center main groove and the shoulder main groove; and a shoulder land portion between the shoulder main groove and the grounding end portion. The center main groove extends in a zigzag manner by alternately arranging a long first groove portion and a short second groove portion that are inclined with respect to the circumferential direction of the tire, respectively, and a bulging portion in a tire width direction is formed in the center land portion, a first groove portion of the center main groove is inclined such that a portion to be grounded later during rolling heads toward the grounding end side, and first lateral grooves each extending in the tire width direction traverses the mediate land portion and the shoulder land portion and forms a notch in the bulging portion in the center land portion.

### Advantage of the Invention

The pneumatic tire has good drainage performance and traction performance, in particular, by the above configuration of the center main groove and the first lateral groove.

### BRIEF DESCRIPTION OF THE DRAWINGS

FIG. 1 A cross-sectional view in the width direction of a pneumatic tire of an embodiment.

FIG. 2 A tread pattern of the pneumatic tire of the embodiment.

FIG. 3 Another tread pattern of the pneumatic tire of the embodiment.

### BEST MODE FOR CARRYING OUT THE INVENTION

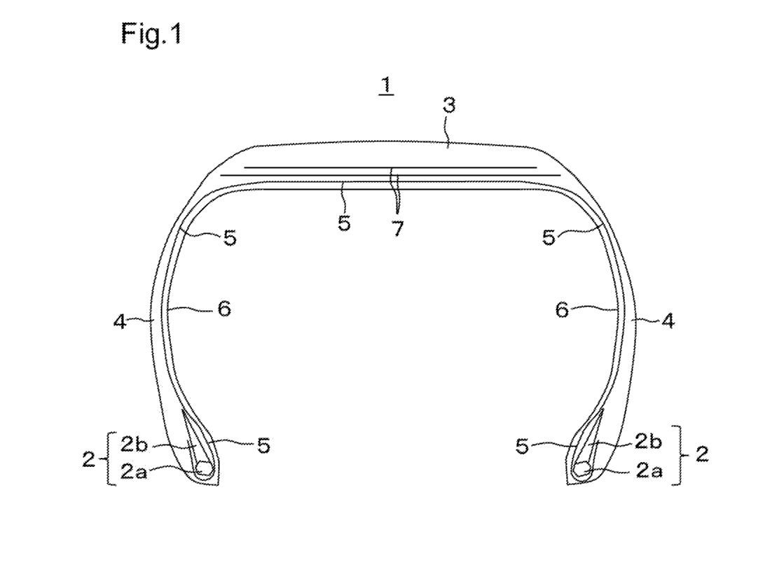

As illustrated in FIG. 1, a bead portion 2 is provided on both sides in a tire width direction of a pneumatic tire 1. The bead portion 2 is constituted by a bead core 2a made of a steel wire wound in a circular shape and a bead filler 2b made of rubber and provided on a radial outer side of the bead core 2a. A carcass ply 5 is laid across the bead portion 2 on both sides in the tire width direction. The carcass ply 5 is a sheet type member in which a plurality of ply cords arranged in a direction orthogonal to a circumferential direction of the tire are covered with rubber. The carcass ply 5 forms a frame shape of the pneumatic tire 1 between the bead portions 2 on both sides in the tire width direction, and surrounds the bead portions 2 by being folded back from inside to outside in the tire width direction around the bead portions 2. A sheet type inner liner 6 made of rubber having low air permeability is adhered to the inside of the carcass ply 5.

One or a plurality of belts 7 are provided on the tire radial outer side of the carcass ply 5. The belt 7 is a member made by covering a plurality of steel-based cords with rubber. A tread rubber 3 having a grounding surface with a road surface (hereinafter, referred to as a “grounding surface”) is provided on the tire radial outer side of the belt 7. Further, a side wall rubber 4 is provided on both sides in the tire width direction of the carcass ply 5. In addition to these members, according to functional requirements of the pneumatic tire 1, members, for example, a belt lower pad or a chafer are provided.

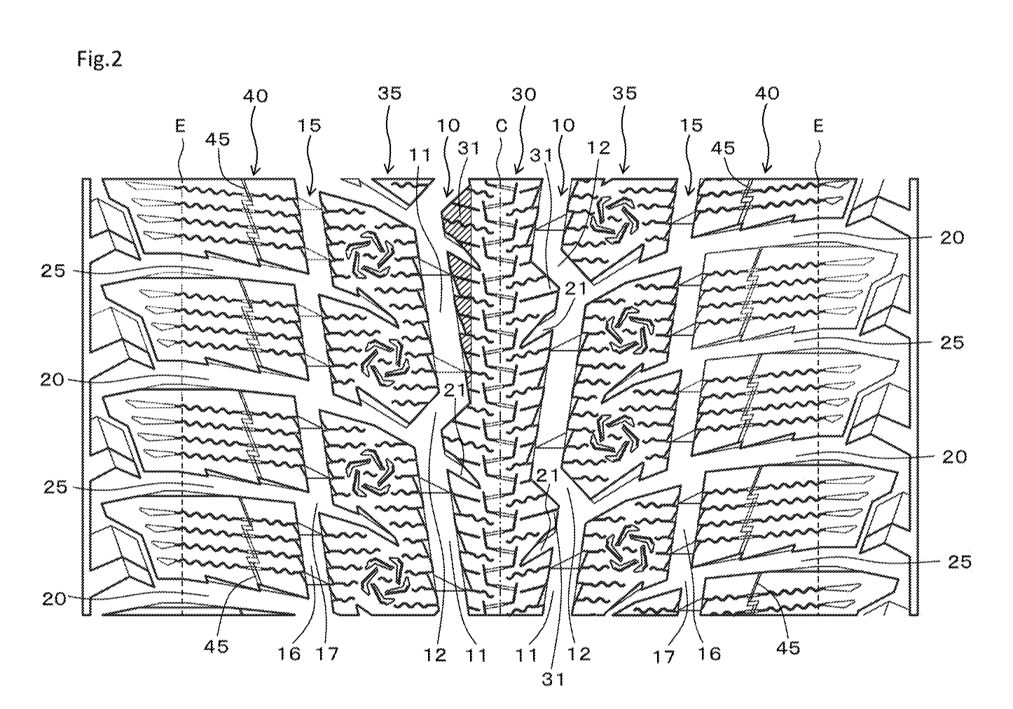

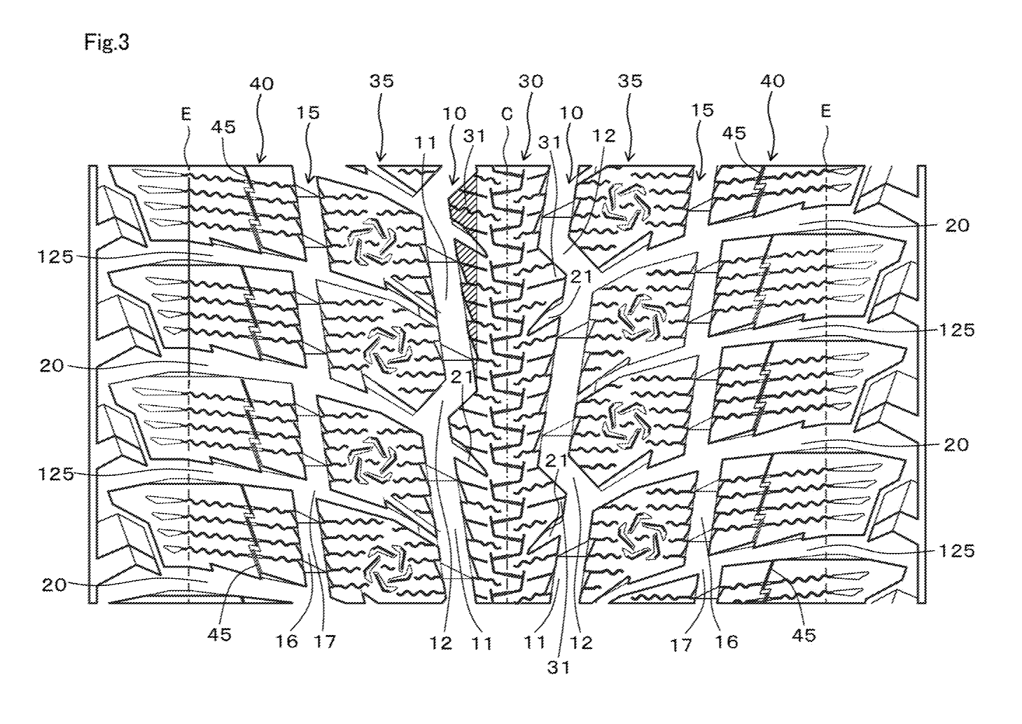

A tread pattern illustrated in FIG. 2 is formed on a surface of the tread rubber 3. In FIG. 2 and FIG. 3 to be described later, the vertical direction is the circumferential direction of the tire, and the lateral direction is the tire width direction. In this tread pattern, as a main groove that extends in the circumferential direction of the tire and has a wide width, a total of four main grooves, that is, two center main grooves 10 on a tire equator C side (center side in the tire width direction) and two shoulder main grooves 15 on a tire grounding end E side (outside in the tire width direction) are formed. Then, a center land portion 30 between the two center main grooves 10, a mediate land portion 35 between the center main groove 10 and the shoulder main groove 15, and a shoulder land portion 40 between the shoulder main groove 15 and the tire grounding end E are provided.

Here, the land portion is a portion formed by being partitioned by grooves. Further, the tire grounding end E is an end portion of the grounding surface in the tire width direction in a loaded state. The loaded state is a state where the pneumatic tire is rim-assembled into a normal rim to be a normal inner pressure and loaded by a normal load. Here, the normal rim is a standard rim defined by standards such as JATMA, TRA, and ETRTO. Further, the normal load is a maximum load defined in the above standards. Further, the normal inner pressure is an inner pressure corresponding to the maximum load.

The center main groove 10 includes long first groove portions 11 that extend obliquely with respect to the circumferential direction of the tire, and short second groove portions 12 that are inclined with respect to the circumferential direction of the tire and extend in a direction different from that of the first groove portion 11. Then, a first groove portion 11 and a second groove portion 12 are arranged alternately, and thus, the center main groove 10 is formed in a zigzag shape. In FIG. 2, a lower side is grounded first during rolling of the tire (that is, when the vehicle is traveling) . As can be seen from the drawing, the first groove portion 11 is inclined such that a portion to be grounded later (in other words, a rear side in the rolling direction) heads toward the tire grounding end E side. The center main groove 10 is shifted in the circumferential direction of the tire on both sides of the tire equator C. That is, the positions of the first groove portion 11 and the second groove portion 12 are shifted in the circumferential direction of the tire on both sides of the tire equator C.

Further, the shoulder main groove 15 includes long first groove portions 16 that extend obliquely with respect to the circumferential direction of the tire, and short second groove portions 17 that are inclined with respect to the circumferential direction of the tire and extend in a direction different from that of the first groove portion 16. Then, the first groove portions 16 and the second groove portions 17 are arranged alternately, and thus, the shoulder main groove 15 has a zigzag shape. As can be seen from FIG. 2, each of the first groove portions 16 is inclined such that a portion to be grounded later heads toward the tire grounding end E side. The shoulder main groove 15 is shifted in the circumferential direction of the tire on both sides of the tire equator C. That is, the positions of the first groove portion 16 and the second groove portion 17 are shifted in the circumferential direction of the tire on both sides of the tire equator C.

The center land portion 30 between the two center main grooves 10 is a rib extending in the circumferential direction of the tire without being divided by lateral grooves. Since the center main groove 10 has a zigzag shape as described above, bulging portions 31 in the tire width direction are formed in the center land portion 30. The bulging portion 31 is a portion bulging toward the tire grounding end E side from a portion of the center main groove 10 of the zigzag shape which is closest to the tire equator C. In FIG. 2, one of the bulging portions 31 is indicated by hatching. Since the center main grooves 10 of the zigzag shape are shifted in the circumferential direction of the tire on both sides of the tire equator C, the bulging portions 31 are also shifted in the circumferential direction of the tire on both sides of the tire equator C.

Meanwhile, the mediate land portion 35 and the shoulder land portion 40 are divided by lateral grooves extending in the tire width direction, and thus, are a plurality of rows of blocks arranged in the circumferential direction of the tire. First lateral grooves 20 and second lateral grooves 25 are formed as the lateral grooves.

A first lateral groove 20 extends obliquely such that a portion close to the tire grounding end E is grounded later during rolling of the tire. Further, the first lateral groove 20 extends in a curved manner. The first lateral groove 20 traverses the shoulder land portion 40 and the mediate land portion 35, and extends to the center land portion 30 and is closed in the center land portion 30. Therefore, a notch 21 that is a part of the first lateral grooves 20 is formed in the center land portion 30. A notch is a groove in which one end is opened in the main groove and the other end is closed in the land portion. The notch 21 is formed in the bulging portion 31 in the center land portion 30. The notch 21 may extend to the tire equator C side from the bulging portion 31 as illustrated in FIG. 2. The positions of the first groove portions 20 and the notches 21, which are a part thereof, are shifted in the circumferential direction of the tire on both sides of the tire equator C.

Further, the second lateral groove 25 extends obliquely such that a portion close to the tire grounding end E is grounded later during rolling of the tire. Further, the second lateral groove 25 extends in a curved manner. The second lateral groove 25 traverses the shoulder land portion 40, and extends to the mediate land portion 35 and is closed in the mediate land portion 35. The positions of the second groove portions 25 are shifted in the circumferential direction of the tire on both sides of the tire equator C.

As a modification, as illustrated in FIG. 3, a second lateral groove 125 may traverse the shoulder land portion 40 and the mediate land portion 35, and then end in the center main groove 10 while being opened. The tread pattern in FIG. 2 is used for, for example, a high-performance tire, and a tread pattern in FIG. 3 is used for, for example, a tire for a sports utility vehicle (SUV).

Such first lateral grooves 20 and second lateral grooves 25 are alternately arranged in the circumferential direction of the tire. While the first lateral groove 20 extends to the bulging portion 31 in the center land portion 30, the second lateral groove 25 extends toward a place between the two bulging portions 31 arranged in the circumferential direction of the tire or toward the vicinity thereof. The second lateral groove 25 does not reach the center land portion 30, of course. The first lateral groove 20 and the second lateral groove 25 overlap with the second groove portion 17 of the shoulder main groove 15.

Further, a sipe 45 extending in the circumferential direction of the tire is formed in the shoulder land portion 40. The sipe 45 is a narrow groove having a narrow width where the opening end to the grounding surface is closed in the loaded state. The sipe 45 is inclined such that a portion to be grounded later during rolling of the tire heads toward the tire grounding end E side.

The pneumatic tire 1 of the present embodiment is excellent in traction performance in the front-rear direction because of the zigzag shape of the center main groove 10. In addition, the center main groove 10 is formed by alternately arranging the first groove portions 11 and the second groove portions 12 having different inclination directions. Since the first groove portions 11 which are longer than the second groove portions are inclined such that a portion to be grounded later heads toward the tire grounding end E side during rolling of the tire, it is excellent in drainage performance to the tire grounding end E side by the center main groove 10. Further, since the first lateral groove 20 traverses the mediate land portion 35 and the shoulder land portion 40, it is excellent in drainage performance to the tire grounding end E side.

Further, since the center main groove 10 has a zigzag shape, the bulging portion 31 in the tire width direction is formed in the center land portion 30, and a width of the center land portion in the vicinity of the bulging portion 31 is widened. Usually, such a portion of the land portion that has a wide width is difficult to be drained. However, in the present embodiment, the first lateral groove 20 extends to the bulging portion 31 in the center land portion 30 to form the notch 21, and thus, water around the bulging portion 31 is also drained through the notch 21. Further, the notch 21 also serves to improve the traction performance. As described above, the pneumatic tire 1 of the present embodiment has good drainage performance and traction performance.

Further, since the shoulder main groove 15 has a zigzag shape, it is excellent in the traction performance in the front-rear direction. In addition, since the shoulder main groove 15 is formed by alternately arranging the first groove portions 16 and the second groove portions 17 having different inclination directions, and the first groove portions 16 which are longer portions are inclined such that a portion to be grounded later heads toward the tire grounding end E side during rolling of the tire, it is excellent in drainage performance to the tire grounding end E side by the shoulder main groove 15.

Further, since the second lateral grooves 25 are formed in addition to the first lateral grooves 20, the traction performance of the pneumatic tire 1 is further improved. Here, the first lateral grooves 20 and the second lateral grooves 25 are alternately arranged in the circumferential direction of the tire and each of the first lateral grooves 20 extends to the bulging portion 31 in the center land portion 30, whereas each of the second lateral grooves 25 does not extend to the center land portion 30. Therefore, the width of the center land portion 30 is narrow between the two bulging portions 31 arranged in the circumferential direction of the tire, and the notch is not formed in the narrow width portion. As a result, rigidity of the center land portion 30 is secured.

Further, since the positions of the first lateral grooves 20 having an effect of improving grounding performance are shifted in the circumferential direction of the tire on both sides of the tire equator C, when looking at the entire tire width direction, the grounding performance is improved not intermittently, but continuously in the circumferential direction of the tire. Further, since the positions of the first lateral grooves 20 are shifted in the circumferential direction of the tire on both sides of the tire equator C, noise generated during traveling is reduced as compared with a case where the first lateral grooves are not shifted. Further, since the positions of the second groove portions 25 are also shifted in the circumferential direction of the tire on both sides of the tire equator C, the same effect may be obtained.

In addition, since the sipe 45 formed in the shoulder land portion 40 that extends in the circumferential direction of the tire is inclined such that a portion to be grounded later heads toward the tire grounding end E side, the sipe 45 also contributes to the improvement of the drainage performance.

Further, since the center main grooves 10 and the shoulder main grooves 15 are shifted in the circumferential direction of the tire on both sides of the tire equator C, noise generated during traveling is reduced as compared with a case where the center main grooves and the shoulder main grooves are not shifted. In addition, when the shape of the two center main grooves 10 becomes line symmetric with respect to the tire equator C as an axis of symmetry, difference in the width between the wide portion and the narrow portion of the center land portion 30 becomes large. However, as illustrated in FIG. 2 or 3, when the two center main grooves 10 are shifted in the circumferential direction of the tire so as not to be line symmetrical with respect to the tire equator C as the axis of symmetry, the difference in the width between the wide portion and the narrow portion of the center land portion 30 does not become too large. Therefore, the rigidity or grounding pressure at the time of grounding is relatively uniform in the circumferential direction of the tire.

The above embodiments are examples, and the scope of the present disclosure is not limited thereto. Various modifications may be made to the above embodiments within the scope without escaping from the purpose of the present disclosure.

### DESCRIPTION OF REFERENCE NUMERALS AND SIGNS

C . . . tire equator, E . . . tire grounding end, 1 . . . pneumatic tire, 2 . . . bead portion, 2a . . . bead core, 2b . . . bead filler, 3 . . . tread rubber, 4 . . . side wall rubber, 5 . . . carcass ply, 6 . . . inner liner, 7 . . . belt, 10 . . . center main groove, 11 . . . first groove portion, 12 . . . second groove portion, 15 . . . shoulder main groove, 16 . . . first groove portion, 17 . . . second groove portion, 20 . . . first lateral groove, 21 . . . notch, 25 . . . second lateral groove, 30 . . . center land portion, 31 . . . bulging portion, 35 . . . mediate land portion, 40 . . . shoulder land portion, 45 . . . sipe, 125 . . . second lateral groove

1. A pneumatic tire comprising: two center main grooves on a tire equator side and two shoulder main grooves on a grounding end side of the tire as main grooves extending in a circumferential direction of the tire; a center land portion between the two center main grooves; a mediate land portion between the center main groove and the shoulder main groove; and a shoulder land portion between the shoulder main groove and the grounding end portion,
wherein the center main groove extends in a zigzag manner by alternately arranging long first groove portions and short second groove portions that are inclined with respect to the circumferential direction of the tire, respectively, and bulging portions in a tire width direction are formed in the center land portion,
each of the first groove portions of the center main groove is inclined such that a portion to be grounded later during rolling heads toward the grounding end side, and
first lateral grooves each extending in the tire width direction traverse the mediate land portion and the shoulder land portion and forms a notch in a bulging portion in the center land portion.

2. The pneumatic tire according to claim 1, further comprising second lateral grooves that extend in the tire width direction to traverse the shoulder land portion, and either end in a middle of the mediate land portion or traverse the mediate land portion and then end in the center main groove while being opened,
wherein the first lateral grooves and the second lateral grooves are alternately arranged in the circumferential direction of the tire.

3. The pneumatic tire according to claim 1, wherein positions of the first lateral grooves are shifted in the circumferential direction of the tire at both sides of the tire equator.

4. The pneumatic tire according to claim 1, wherein the shoulder main groove extends in a zigzag manner by alternately arranging long first groove portions and short second groove portions that are inclined with respect to the circumferential direction of the tire, respectively,
each of the first groove portions of the shoulder main groove is inclined such that a portion to be grounded later during rolling heads toward the grounding end side.

5. The pneumatic tire according to claim 1, wherein a sipe that extends in the circumferential direction of the tire is formed in the shoulder land portion, and the sipe is inclined such that a portion to be grounded later heads toward the grounding end side.
